(19) United States
(12) Patent Application Publication
(10) Pub. No.: US 2013/0072685 A1
(43) Pub. Date: Mar. 21, 2013

(54) Process For Producing 3,7-Diaza-Bicyclo[3.3.1]Nonane-Metal Complexes

(71) Applicants: Gerd Reinhardt, Kelkheim (DE); Miriam Ladwig, Dietzenbach (DE); Michael Best, Bad Soden (DE); Thorsten Schneider, Hadamar (DE); Ernst Spicker, Frankfurt am Main (DE)

(72) Inventors: Gerd Reinhardt, Kelkheim (DE); Miriam Ladwig, Dietzenbach (DE); Michael Best, Bad Soden (DE); Thorsten Schneider, Hadamar (DE); Ernst Spicker, Frankfurt am Main (DE)

(73) Assignee: CLARIANT FINANCE (BVI) LIMITED, Tortola (VG)

(21) Appl. No.: 13/575,747

(22) PCT Filed: Jan. 28, 2011
(86) PCT No.: PCT/EP2011/000404

§ 371 Date: Oct. 30, 2012

(30) Foreign Application Priority Data
Feb. 6, 2010 (DE) 10 2010 007 059.9

(51) Int. Cl. C07F 15/02; C07F 13/00

(52) U.S. Cl. CPC C07F 15/025
USPC 546/10

(57) ABSTRACT

The invention describes a process for producing metal complexes of the general formula (2): [MₐLₓXₙ]Yₘ (2), where M is a metal from the group comprising Mn(II), Mn(III), Mn(IV), Fe(II), Fe(III) or Fe(IV), X is a coordinated compound selected from mono- bi- or tri-charged anions or neutral molecules which are able to coordinate with a metal mono- bi- or tri-dentate, Y represents a non-coordinated counter-ion which ensures charge equalization of the complex, L represents a ligand of the general formula (1) or the protonized or de-protonized form thereof, and a, x, n, m, R, R¹, R², R³ and z have the meaning specified in claim 1. Said process is characterized in that the reaction of a ligand of the formula (1) with an iron or manganese salt in a heterogeneous reaction is carried out in water, where the reaction is carried out in a temperature range of 35 to 50° C. and the pH value of the reaction mixture is from 1 to 3 after the addition of the iron or manganese salt.

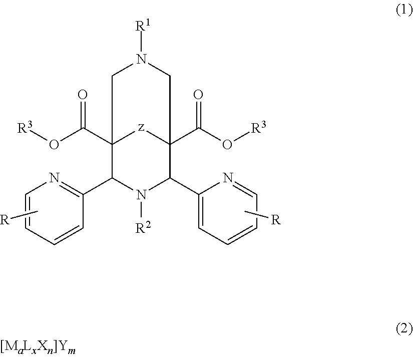

The invention relates to a process for preparing iron or manganese complexes with 3,7-diazabicyclo[3.3.1]nonane ligands in heterogeneous, aqueous systems.

3,7-Diazabicyclo[3.3.1]nonane compounds are compounds of interest for various applications. Among other things, transition metal complexes containing a ligand of the formula (1) are very effective catalysts which can be used in combination with peroxides for bleaching of colored stains in washing and cleaning compositions. Examples thereof can be found in WO 00/60045 and EP 1 678 286. For this application, high product purities are required, since traces of free metal ions can contribute to unwanted side reactions and hence to damage to the laundry. Some of these complexes, however, are also very active in the presence of atmospheric oxygen and enable bleaching of oily stains without using the otherwise customary hydrogen peroxides or inorganic per salts. Examples thereof are described, inter alia, in WO 03/104234.

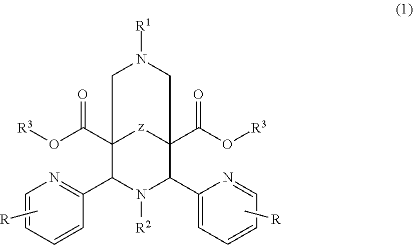

Due to their mechanism of action with oxygen, a further field of use for this substance class has opened up in recent times. For instance, WO 2008/003652 describes the use of such transition metal complexes as catalysts for the drying of alkyd-based paints and coatings. They serve here as an environmentally friendly alternative to cobalt-containing fatty acid derivatives which are suspected of causing cancer.

Ligands of the formula (1) and metal complexes thereof have been described in detail in the literature. Ligand synthesis is described, for example, in WO 2006/133869, while WO 02/488301, Inorg. Chimica Acta, 337 (2002) 407-419 and Eur. J. Org. Chem. (2008) 1019-1030 describe complexation reactions.

The known complex syntheses are effected by reaction of the respective ligand of the formula (1) with a metal salt in homogeneous solution. Both the ligand and the metal salt are dissolved separately in different organic solvents and then the complex formation is conducted in homogeneous solution. Operation is effected here under argon or nitrogen under anhydrous conditions. Since the metal complexes formed also have good solubility in the solvent mixture, a further solvent has to be used for isolation of the complexes, in order to be able to isolate the product in crystalline form. The yields are only moderate and are between 40 and 70%.

The synthesis processes described require, for the isolation of the end product, high additions of solvent for purification, for example methanol, ethyl acetate, acetone or dichloromethane. The choice of solvents and the strictly anhydrous conditions (anhydrous solvents, argon or nitrogen blanketing of the reaction) lead to problems and expense on industrial scale implementation. There was therefore a need for an improved process performable on the industrial scale for preparation of such complexes.

It has now been found that, surprisingly, iron and manganese complexes of the formula (2) can be prepared in a heterogeneous reaction in water, even though ligands of the formula (1) are virtually insoluble in water. Furthermore, it is possible to improve the space-time yield with observation of particular reaction conditions to arrive at the desired metal complexes in high yields and purities.

The present invention therefore provides a process for preparing one or more metal complexes of the general formula (2)

[MₐLₓXₙ]Yₘ (2)

where
M is a metal from the group of Mn(II), Mn(III), Mn(IV), Fe(II), Fe(III) and Fe(IV),
X is a coordinating compound selected from singly, doubly and triply charged anions and uncharged molecules capable of mono-, bi- or tridentate coordination to a metal, preferably OH⁻, NO₃⁻, NO, S²⁻, R^{a}S⁻, PO₄³⁻, H₂O, CO₃²⁻, R^{b}OH, Cl⁻, Br⁻, CN⁻, ClO₄⁻, R^{a}COO⁻ or SO₄²⁻, where R^{a} is H or C₁-C₄ alkyl and R^{b} is C₁-C₄ alkyl,
Y is a noncoordinating counterion which ensures the charge balance of the complex, preferably R^{c}SO₄⁻, SO₄²⁻, NO₃⁻, Cl⁻, Br⁻, I⁻, ClO₄³¹ , BF₄⁻, PF₆⁻ or R^{c}SO₃⁻, where R^{c} is H or C₁-C₄ alkyl,
a is a number from 1 to 2,
x is a number from 1 to 2,
n is a number from 0 to 4,
m is a number from 0 to 8, and
L is a ligand of the general formula (1) or the protonated or deprotonated form thereof

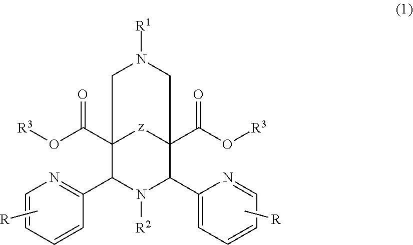

where
R is hydrogen, hydroxyl or C₁-C₄ alkyl;
R¹ is C₁-C₄ alkyl, C₆-C₁₀ aryl, pyridinyl-C₁-C₄-alkyl or (CH₂)ₖN(C₁-C₄-alkyl)₂;
R² is C₁-C₂₀ alkyl, C₆-C₁₀ aryl or pyridinyl-C₁-C₄-alkyl;
R³ is C₁-C₄ alkyl;
z is C═O or C(OH)₂ and
k is a number from 1 to 6,
   which comprises performing the reaction of one or more ligands of the formula (1) with an iron or manganese salt, especially iron(II) chloride, in heterogeneous reaction in water, the reaction being performed within a temperature range from 35 to 50° C., preferably from 40 to 46° C., and the pH of the reaction mixture after addition of the iron or manganese salt, especially of the iron(II) chloride, being from 1 to 3 and preferably from 1.5 to 2.5.

Particular preference is given to preparing, by the process according to the invention, one or more complexes of the formula [FeLCl]Cl, [FeL(SO₄)], [MnLCl]Cl, [MnL(SO₄)], [FeLCl]PF₆, [FeL(H₂O)][PF₆]₂ or [FeL(H₂O)][BF₄]₂, where L is especially selected from the group consisting of

dimethyl 2,4-di(2-pyridyl)-3-methyl-7-(pyridin-2-ylmethyl)-3,7-diazabicyclo-[3.3.1]nonan-9-one-1,5-dicarboxylate (N2Py3o),

dimethyl 2,4-di(2-pyridyl)3-(pyridin-2-ylmethyl)-7-methyl-3,7-diazabicyclo-[3.3.1]nonan-9-one-1,5-dicarboxylate (N2Py3u),

diethyl 2,4-di(2-pyridyl)-3-methyl-7-(pyridin-2-ylmethyl)-3,7-diazabicyclo-[3.3.1]nonan-9-one-1,5-dicarboxylate,

dimethyl 2,4-di(2-pyridyl)-3,7-bis(pyridin-2-ylmethyl)-3,7-diazabicyclo[3.3.1]-nonan-9-one-1,5-dicarboxylate (N2Py4),

dimethyl 2,4-di(2-pyridyl)-3,7-dimethyl-3,7-diazabicyclo[3.3.1]nonan-9-one-1,5-dicarboxylate (N2Py2),

diethyl 2,4-di(2-pyridyl)-3,7-dimethyl-3,7-diazabicyclo[3.3.1]nonan-9-one-1,5-dicarboxylate,

dimethyl 2,4-di(2-pyridyl)-3-methyl-7-(N,N′-dimethylethylamine)-3,7-diaza-bicyclo[3.3.1]nonan-9-one-1,5-dicarboxylate

and the corresponding dihydroxy ketals.

In an embodiment of the invention which is preferred in turn, the process according to the invention is used to prepare one or more complexes of the formula [FeLC]Cl, [FeL(SO₄)], [MnLCl]Cl or [MnL(SO₄)], more preferably one or more complexes of the formula [FeLCl]Cl or [FeL(SO₄)] and especially preferably one or more complexes of the formula [FeLCl]Cl.

Ligands of the general formula (1) used in the process according to the invention are complexed by the process and are thus found in the metal complexes of the general formula (2) prepared. However, they can be modified in the metal complexes of the general formula (2) in such a way that a ketone or carbonyl group z (z=C═O) present in the starting ligands of the general formula (1) is converted to the hydrated form (z=C(OH)₂) during the process according to the invention by the presence of water. This means that the ligands in the metal complexes of the general formula (2) may be present as dihydroxy ketals even if they have been used in the form of the ketones in the process according to the invention.

The fact that the ligands are often present in complexed form as dihydroxy ketals (z=C(OH)₂) is shown, for example, in Inorg. Chimica Acta, 337 (2002) 407-419 by X-ray structure analysis.

The ligands can be prepared on the industrial scale according to the information in DE 601 20 781 or WO 2006/133869 as per the following reaction scheme:

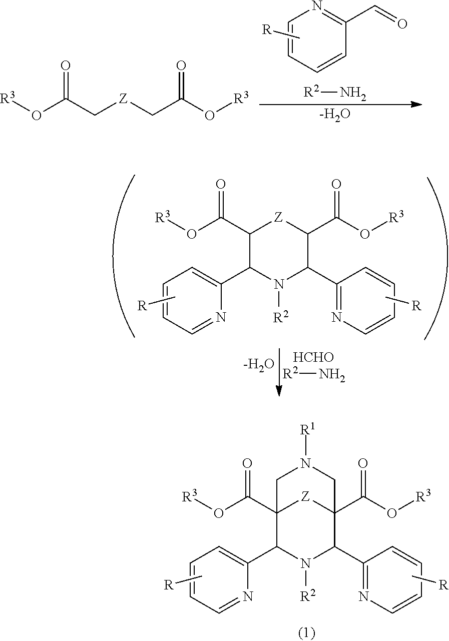

Proceeding from dicarboxylic diester, two Mannich condensation steps with elimination of water are conducted in a C₁-C₄ alcohol, for example ethanol, propanols or butanols. After removal of water has ended, the mixture is cooled and the product is filtered off and washed. According to the preparation, the ligands may be obtained in the form of crystals of greater or lesser size. For the complexation reaction, they can then be used either in solvent-moist form or in dried form. Even though it is supposed to be advantageous for the complexation reaction to use very small crystals in the heterogeneous complexation reaction, comminution is not absolutely necessary for the conversion to be successful.

In a further preferred embodiment of the process according to the invention, the ligands of the general formula (1) are selected from the group consisting of dimethyl 2,4-di(2-pyridyl)-3-methyl-7-(pyridin-2-ylmethyl)-3,7-diazabicyclo[3.3.1]nonan-9-one-1,5-dicarboxylate (N2Py3o), dimethyl 2,4-di(2-pyridyl)-3,7-dimethyl-3,7-diazabicyclo[3.3.1]nonan-9-one-1,5-di-carboxylate (N2Py2) and the corresponding dihydroxy ketals.

The iron or manganese salt used in the process according to the invention is also referred to hereinafter as “metal salt” for short.

The process according to the invention consists quite generally in suspending the one or more ligands in water and complexing them with a metal salt.

Coordinating compounds X of the metal complexes of the general formula (2) originate preferably from the iron or manganese salt used in the process according to the invention. However, they may also originate, for example, from the solvent, especially when X═H₂O.

Special preference is given to coordinating compounds X selected from the group consisting of Cl⁻ and SO₄²⁻. Preference is given among these to Cl⁻.

Noncoordinating counterions Y can also preferably originate from the iron or manganese salt used in the process according to the invention, for example when Y has the same definition as X.

Special preference is given to noncoordinating counterions Y selected from the group consisting of Cl⁻ and SO₄²⁻. Preference is given among these to Cl⁻.

In a preferred embodiment of the invention, X and Y have the same definition.

The metal salt used for the process according to the invention is preferably a metal(II) salt. In a preferred embodiment of this aspect of the invention, the metal(II) salt is an iron(II) salt, particular preference being given to iron(II) chloride and iron(II) sulfate. In a further preferred embodiment of this aspect of the invention, the metal(II) salt is selected from the group consisting of iron(II) chloride, iron(II) sulfate, manganese(II) chloride and manganese(II) sulfate. An especially preferred metal salt is iron(II) chloride.

In a particularly preferred embodiment of the process according to the invention, one or more complexes of the formula [FeLC]Cl are prepared in which L is dimethyl 2,4-di(2-pyridyl)-3-methyl-7-(pyridin-2-ylmethyl)-3,7-diazabicyclo[3.3.1]nonan-9-one-1,5-dicarboxylate (N2Py3o) or the corresponding dihydroxy ketal. In this case, dimethyl 2,4-di(2-pyridyl)-3-methyl-7(pyridin-2-ylmethyl)-3,7-diazabicyclo[3.3.1]-nonan-9-one-1,5-dicarboxylate or the corresponding dihydroxy ketal, or mixtures thereof, are reacted with with iron(II) chloride.

In a further preferred embodiment of the process according to the invention, the ligands L are used in the process in the form of the ketones (z=C═O).

In a further preferred embodiment of the process according to the invention, one or more metal complexes of the general formula (2) are prepared in which the complexed ligands L are present in the form of the dihydroxy ketals (z=C(OH)₂).

The synthesis is effected in such a way that the one or more ligands of the formula (1) are suspended in water and admixed by stirring with a metal salt in solid or dissolved form in a heterogeneous reaction. The water:ligand weight ratio is preferably from 4:1 to 1:1, more preferably from 2:1 to 1.2:1. The molar ratio of ligand:metal salt is preferably from 0.9:1 to 1.2:1, particular preference being given to using 0.99 to 1.03 mol of metal salt per 1 mol of ligand. The metal salt can be used in solid form, either in anhydrous form or preferably in hydrate form (for example as the tetrahydrate), but more preferably in aqueous solution in a concentration of 10 to 50% by weight, but preferably from 20 to 40% by weight.

In the case of addition of the metal salt to the suspended ligands, slight exothermicity occurs, but the reaction remains heterogeneous over the entire reaction time. The conversion of the reaction is monitored analytically (for example by means of HPLC).

The metal complexes of the formula (2) can be removed as solids from the reaction mixture by the methods familiar to the person skilled in the art, preferably by filtration. The complex is preferably subsequently dried, in which case it can preferably also be washed prior to the drying.

It has been found that, surprisingly, the temperature and the pH during the metal salt addition and the continued stirring time exert a crucial influence on the reaction times and filtration properties, and hence on the yield and purity. The pH of the reaction mixture after addition of the metal salt (in solid or dissolved form) is from 1 to 3 and preferably from 1.5 to 2.5. The pH can be adjusted by addition of an acid to the suspended ligands or via the pH of the metal salt solution.

If the reaction is conducted at temperatures below 30° C., a structurally viscous suspension of a finely crystalline complex forms, the isolation of which is barely possible by means of conventional filter apparatus, since the filter is blocked, resulting in extremely long filtration times. The poor filterability complicates the washing and hence the purification of the complex to free it of excess metal traces or unconverted ligands. The high moisture content in the filtercake results in extremely long drying times, and mother liquor remaining in the filtercake leads to conglutination of the dried filtercake, such that subsequent grinding is unavoidable in order to obtain a pulverulent end product.

If the reaction is conducted above 50° C., the ligands of the formula (1) begin to decompose under the acidic conditions of the reaction solution, as a result of which the yield of end product is severely reduced. Possible reactions could be, inter alia, hydrolysis of the ester bond or retro-Mannich reactions.

In a preferred embodiment of the process according to the invention, the heterogeneous complexation reaction is therefore performed at temperatures of 40 to 46° C. and more preferably of 42 to 45° C., and a pH of 1.5 to 2.5. In this way, crystalline metal complexes with very good filtration properties and low residual moisture contents in the filtercake are obtained in high yields. After drying, a free-flowing powder is obtained, the grinding of which can be dispensed with.

In a further preferred embodiment of the invention, X and Y have different definitions. In this case, it is possible, for example, first to prepare metal complexes of the general formula (2) in which X and Y have the same definition and are more preferably chloride, and then to exchange the non-coordinating counterion Y. In this procedure, for exchange of Y, preference is given to using an alkali metal or alkaline earth metal salt containing the new noncoordinating counterion Y. For example, it is possible to obtain metal complexes of the general formula (2) where Y═PF₆⁻ (hexafluorophosphates) by first preparing metal complexes where X═Y═Cl⁻ and then exchanging the noncoordinating Cl⁻ counterion by means of KPF₆ for the new noncoordinating PF₆⁻ counterion. Such exchange reactions are common knowledge to the person skilled in the art.

Compared to the prior art processes, a higher space-time yield, short filtration times and high product purities are achieved in the process according to the invention. Dispensing with organic solvents additionally allows an inexpensive production process.

Examples which follow are intended to illustrate the invention in detail without restricting it thereto.

### EXAMPLES

### Preparation of the dimethyl 2,4-di(2-pyridyl)-3-methyl-7-(pyridin-2-ylmethyl)-3,7-diazabicyclo[3.3.1]nonan-9-one-1,5-dicarboxylate ligand (N2Py3o)

11.2 kg of dimethyl acetonedicarboxylate (purity 97% by weight; 64 mol) are dissolved in 15 kg of isobutanol. The solution is cooled to 10° C., then 13.4 kg of pyridine-2-aldehyde (purity 99% by weight, 125 mol) in 10 kg of isobutanol, followed by 4.8 kg of methylamine (40% by weight in water, 62 mol), are added dropwise such that the temperature is maintained with constant cooling. The reaction mixture is then heated to 40-45° C. and an azeotrope (17 liters) of isobutanol and water is distilled off under reduced pressure at internal temperature 40-45° C. During this, 15 liters of iso-butanol are metered in continuously. After cooling to room temperature, 8.4 kg of aminomethylpyridine (78 mol) are metered in and the metering funnel is rinsed with 7.0 kg of isobutanol. Then 13.5 kg of formaldehyde solution (37% by weight in water, 166.5 mol) are added within 15-30 minutes. After addition has ended, the mixture is heated to 55-60° C. and stirred for a further 1.5 hours. Subsequently, at maximum internal temperature 60° C., 55 kg of azeotropic mixture of isobutanol and water are distilled off, while 36 kg of isobutanol are added continuously. The mixture is vented with nitrogen and cooled to room temperature. The precipitate formed is filtered off and washed with isobutanol. The ligand can be used in the complexation reaction in the form of the moist filtercake, or else dried under reduced pressure at 50° C. This affords 23.3 kg (72.1%) of dimethyl 2,4-di(pyridyl)-3-methyl-7-(pyridin-2-ylmethyl)-3,7-diazabicyclo[3. 3.1 ]nonan-9-one-1,5-dicarboxylate in the form of a colorless, crystalline powder.

### Example 1

A reaction vessel is charged with 220.0 kg (12.2 mol) of water and 145.1 kg (280 mol) of dimethyl 2,4-di(2-pyridyl)-3-methyl-7-(pyridin-2-ylmethyl)-3,7-diazabicyclo[3.3.1]nonan-9-one-1,5-dicarboxylate (N2Py3o), purity 99.5%, and a homogeneous suspension is produced while stirring. Subsequently, 119.5 kg (283 mol) of aqueous iron(II) chloride solution (30.2% by weight) are added within 120 minutes. After addition for 30 minutes, the pH of the reaction mixture is approx. 1.8. During this time, the reaction mixture is heated to 42 to 45° C. The course of the reaction is monitored by means of HPLC analysis. The reaction solution is stirred at 42 to 45° C. for 8 hours, in the course of which the pH rises to 2. Measurements of the particle size distribution of the complex of the formula (2) formed give an average value of 50 to 70 μm. Subsequently, the solids are filtered off using a suction filter. Due to the good filtration properties, a filtercake with residual moisture content 25% by weight is obtained after a filtration time of 30 minutes, and is subsequently dried in a drying cabinet at 50° C. within 24 hours in order to achieve a residual moisture content of <1% by weight. In this way, iron (1+), chloro[dimethyl 9,9-dihydroxy-3-methyl-2,4-di(2-pyridinyl-κN)-7-[(2-pyridinyl-κN)methyl]-3,7-diazabicyclo[3.3.1 ]nonane-1,5-dicarboxylate-κN3,κn7]-, chloride (1:1) is obtained as a yellow free-flowing powder. Yield (telquel): 97.7%; purity: 98.5%; yield: 96.2%.

### Comparative Example 1

The procedure is analogous to example 1, except that the reaction is conducted within the temperature range from 20 to 24° C. and at a start pH (30 minutes after commencement of the dropwise addition time of the iron(II) chloride solution) of 5.5. The course of the reaction is monitored by means of HPLC measurement. The reaction solution has to be stirred at 20 to 24° C. for 25 hours in order to complete the reaction, in the course of which the pH declines to 1.7. Measurements of the particle size distribution of the complex of the formula (2) formed give an average value of 18 to 30 μm. Subsequently, the solids are filtered off using a suction filter. Due to the poor filtration properties, a filtercake with residual moisture content 44% by weight is obtained after a filtration time of 160 minutes, and is subsequently dried in a drying cabinet at 50° C. within 125 hours in order to achieve a residual moisture content of <1% by weight. In this way, iron (1+), chloro[dimethyl 9,9-dihydroxy-3-methyl-2,4-di(2-pyridinyl-κN)-7-[(2-pyridinyl-κN)methyl]-3,7-diazabicyclo[3.3.1]nonane-1,5-dicarboxylate-κN3,κn7]-, chloride (1:1) is obtained as a yellow-brown caked solid, which has to be ground prior to further processing. Yield (telquel): 96.7%; purity: 95.4%; yield: 92.2%.

This comparative example shows that the reaction conditions which do not correspond to those of the process according to the invention triple the reaction time and quintuple the filtration time and drying time, and absolutely necessitate grinding of the end product.

### Example 2 and Comparative Examples C2 and C3

General Method

A 1 liter 5-neck flask is initially charged with 155.4 g (0.3 mol) of N2Py3o (purity 99.5% by weight) and 240 g of 247.8 g of demineralized water. The mixture is suspended at room temperature for 1 hour. While stirring, 126.8 g (0.3 mol) of FeCl₂ solution (30.0% by weight) is added dropwise within one hour. The mixture is stirred for a further 3 hours. The suspension is filtered through a suction filter, and the solids are washed and dried at 50° C. under an N₂ blanket.

| | C2 | C3 | Example 2 |
|---|---|---|---|
| Dropwise addition temperature [° C.] | 25-30 | 25-30 | 30-40 |
| Continued stirring temperature [° C.] | 25-30 | 50-52 | 42-45 |
| pH after addition of the FeCl₂ solution | 3.2 | 3.2 | 2.0 |
| Final pH | 3.3 | 1.7 | 1.9 |
| Particle size [μm] | 18 | 54 | 67 |
| Filterability | poor | good | good |
| Residual moisture content in the | 35 | 18 | 15 |
| filtercake [% by wt.] | | | |
| Yield (telquel) [%] | 96.4 | 88.0 | 97.6 |
| Purity [%] | 94 | 98 | 98 |
| Yield [%] | 91 | 86 | 96 |
| Product form | lumps | powder | powder |

1. A process for preparing at least one metal complex of the general formula (2)
[MₐLₓXₙ]Yₘ (2)
where
M is a metal selected from the group consisting of Mn(II), Mn(III), Mn(IV), Fe(II), Fe(III) and Fe(IV),
X is a coordinating compound selected from the group consisting of singly, doubly and triply charged anions and uncharged molecules capable of mono-, bi- or tridentate coordination to a metal,
Y is a noncoordinating counterion which ensures the charge balance of the complex,
a is a number from 1 to 2,
x is a number from 1 to 2,
n is a number from 0 to 4,
m is a number from 0 to 8, and
L is a ligand of the general formula (1) or the protonated or deprotonated form thereof 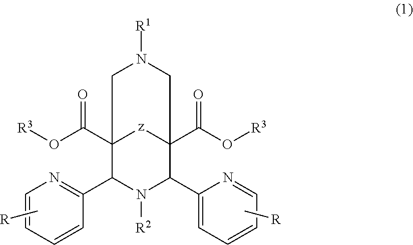
where
R is hydrogen, hydroxyl or C₁-C₄ alkyl;
R¹ is C₁-C₄ alkyl, C₆-C₁₀ aryl, pyridinyl-C₁-C₄-alkyl or (CH₂)ₖN(C₁-C₄-alkyl)₂;
R² is C₁-C₂₀ alkyl, C₆-C₁₀ aryl or pyridinyl-C₁-C₄-alkyl;
R³ is C₁-C₄ alkyl;
is C═O or C(OH)₂ and
k is a number from 1 to 6,
which comprises the step of reacting at least one ligand of the formula (1) with an iron or manganese salt in heterogeneous reaction in water, wherein the reaction is performed within a temperature range from 35 to 50° C. and the pH of the reaction mixture after addition of the iron or manganese salt is from 1 to 3.

2. The process as claimed in claim 1, wherein X is selected from the group consisting of OH⁻, NO₃⁻, NO, S²⁻, R^{a}S⁻, PO₄³⁻, H₂O, CO₃²⁻, R^{b}OH, Cl⁻, Br⁻, CN⁻, ClO₄⁻, R^{a}COO⁻ and SO₄²⁻, where R^{a} is H or C₁-C₄ alkyl and R^{b} is C₁-C₄ alkyl.

3. The process as claimed in claim 1, wherein Y is selected from the group consisting of R^{c}SO₄⁻, SO₄²⁻, NO₃⁻, Cl⁻, Br⁻, I⁻, ClO₄⁻, BF₄⁻, PF₆⁻ and R^{c}SO₃⁻, where R^{c} is H or C₁-C₄ alkyl.

4. The process as claimed in claim 1, wherein the reaction is performed within a temperature range from 40 to 46° C.

5. The process as claimed in claim 1, wherein the pH of the reaction mixture after addition of the iron or manganese salt is from 1.5 to 2.5.

6. The process as claimed in claim 1, wherein at least one complex of the formula [FeLCl]Cl, [FeL(SO₄)], [MnLCl]Cl, [MnL(SO₄)], [FeLCl]PF₆, [FeL(H₂O)][PF₆]₂ or [FeL(H₂O)][BF₄]₂ is prepared, where L is selected from the group consisting of
dimethyl 2,4-di(2-pyridyl)-3-methyl-7-(pyridin-2-ylmethyl)-3,7-diaza-bicyclo[3.3.1]nonan-9-one-1,5-dicarboxylate (N2Py3o),
dimethyl 2,4-di(2-pyridyl)3-(pyridin-2-ylmethyl)-7-methyl-3,7-diaza-bicyclo[3.3.1]nonan-9-one-1,5-dicarboxylate (N2Py3u),
diethyl 2,4-di(2-pyridyl)-3-methyl-7-(pyridin-2-ylmethyl)-3,7-diaza-bicyclo[3.3.1]nonan-9-one-1,5-dicarboxylate,
dimethyl 2,4-di(2-pyridyl)-3,7-bis(pyridin-2-ylmethyl)-3,7-diazabicyclo-[3.3.1]nonan-9-one-1,5-dicarboxylate (N2Py4),
dimethyl 2,4-di(2-pyridyl)-3,7-dimethyl-3,7-diazabicyclo[3.3.1]nonan-9-one-1,5-dicarboxylate (N2Py2),
diethyl 2,4-di(2-pyridyl)-3,7-dimethyl-3,7-diazabicyclo[3.3.1]nonan-9-one-1,5-dicarboxylate,
dimethyl 2,4-di(2-pyridyl)-3-methyl-7-(N,N′-dimethylethylamine)-3,7-diaza-bicyclo[3.3.1]nonan-9-one-1,5-dicarboxylate
and the corresponding dihydroxy ketals.

7. The process as claimed in claim 1, wherein the at least one ligand of the general formula (1) is selected from the group consisting of dimethyl 2,4-di(2-pyridyl)-3-methyl-7-(pyridin-2-yl-methyl)-3,7-diazabicyclo[3.3.1]nonan-9-one-1,5-dicarboxylate (N2Py3o), dimethyl 2,4-di(2-pyridyl)-3,7-dimethyl-3,7-diazabicyclo[3.3.1]nonan-9-one-1,5-dicarboxylate (N2Py2) and the corresponding dihydroxy ketals.

8. The process as claimed in claim 2, wherein X is selected from the group consisting of Cl⁻ and SO₄²⁻.

9. The process as claimed in claim 3, wherein Y is selected from the group consisting of Cl⁻ and SO₄²⁻.

10. The process as claimed in claim 1, wherein the iron or manganese salt used is a metal(II) salt.

11. The process as claimed in claim 10, wherein the metal(II) salt is selected from the group consisting of iron(II) chloride, iron(II) sulfate, manganese(II) chloride and manganese(II) sulfate.

12. The process as claimed in claim 11, wherein the metal(II) salt is iron(II) chloride.

13. The process as claimed in claim 1, wherein at least one complex of the formula [FeLC]Cl is prepared by reacting L, wherein L is selected from the group consisting of dimethyl 2,4-di(2-pyridyl)-3-methyl-7-(pyridin-2-ylmethyl)-3,7-diazabicyclo[3.3.1]nonan-9-one-1,5-dicarboxylate (N2Py3o) or the corresponding dihydroxy ketal, and dimethyl 2,4-di(2-pyridyl)-3-methyl-7-(pyridin-2-ylmethyl)-3,7-diazabicyclo[3.3.1]-nonan-9-one-1,5-dicarboxylate or the corresponding dihydroxy ketal, and mixtures thereof, with iron(II) chloride.

14. The process as claimed in claim 1, wherein the at least one ligand L is in the form of a ketone.

15. The process as claimed in claim 1, wherein the at least one metal complex of the general formula (2) is prepared in which the complexed ligand L is present in the form of a dihydroxy ketal.

16. The process as claimed in claim 1, wherein the heterogeneous complexation reaction is performed at temperatures from 42 to 45° C. and a pH of 1.5 to 2.5.

17. The process as claimed in claim 2, wherein X is Cl⁻.

18. The process as claimed in claim 3, wherein Y is Cl⁻.
